(19) United States
(12) Patent Application Publication
(10) Pub. No.: US 2016/0060080 A1
(43) Pub. Date: Mar. 3, 2016

(54) COLLAPSIBLE CRANE CAPABLE OF BEING TRANSPORTED BY CONTAINER

(71) Applicant: KG INC., Incheon (KR)

(72) Inventor: Duckrae CHO, Bucheon (KR)

(73) Assignee: KG INC., Incheon (KR)

(21) Appl. No.: 14/888,851

(22) PCT Filed: Jul. 21, 2014
(86) PCT No.: PCT/KR2014/006584

§ 371 Date: Nov. 3, 2015

(30) Foreign Application Priority Data
Jul. 26, 2013 (KR) 10-2013-0088791

(51) Int. Cl. B66C 19/02; B66C 17/00

(52) U.S. Cl. CPC B66C 19/02; B66C 17/00

(57) ABSTRACT

Disclosed therein is a collapsible crane capable of being transported by a container which includes a girder including a first girder of the left side, a second girder of the right side and a third girder of the middle side, the first girder and the second girder are detachably connected to flanges of the both ends of the third girder, and components mounted on the first girder, the second girder and the third girder are collapsed to come into contact with the first girder, the second girder and the third girder. Therefore, because the girder is separated into the first girder, the second girder and the third girder, and the components, such as saddles, inspection deck and a walk way hand rail, mounted on the first girder, the second girder and the third girder are collapsed toward the girders so as to come into contact with the girders, it minimizes the volume of the assembly of the first girder, the second girder and the third girder, so that the girders can be packed in the space of the standardized container by units. Therefore, because the crane which is heavy, long and large can be disassembled and collapsed and packed in the container by units, the crane can be transported by a general container without any special transporting vehicle not only in a land route but also in a sea route, thereby remarkably reducing transporting costs and the transporting period.

### TECHNICAL FIELD

The present invention relates to a collapsible crane capable of being transported by a container. More specifically, each component of the collapsible crane is disposed separably or collapsibly, thereby being assembled after being transported in a state where it is accommodated in a small-sized container and being kept for re-use after being disassembled.

### BACKGROUND ART

A crane is a machine or a device for lifting and horizontally transporting heavy things using electric power,

and handles the heavy things in a three-dimensional space by actions to hoist and lower the heavy things, by actions to travel, transverse and rotate to horizontally move the hoisted heavy thing, and by combinations of the actions.

Such a crane includes a pair of traveling rails, a girder mounted on the traveling rails to be conveyed along the rails, and a hoist mounted on the girder to be conveyed together with the girder.

Traveling wheels are mounted at both ends of the girder and seated on the traveling rails, and a traveling motor is mounted on the traveling wheels.

Therefore, when the traveling motor is operated, the traveling wheels are rotated and the girder is conveyed along the traveling rails.

The hoist mounted on the girder includes a hoist frame for supporting the entire hoist to the girder; a transverse motor mounted on the hoist frame and seated on the girder so as to convey the hoist frame along the girder; a wire drum rotatably mounted on the hoist frame so that a wire rope is wound thereon or released from the wire drum; a hoist motor connected to the wire drum to operate the wire drum; and a hook connected to the bottom end of the wire rope so as to be lifted up and down along the wire rope when the wire rope is wound on the wire drum or released from the wire drum.

In order to hoist a heavy thing on such a general crane, first, the traveling motor is operated to convey the girder on the X-axis or the Y-axis of the heavy thing. After that, the transverse motor is operated to convey the hoist mounted on the girder on the Y-axis or the X-axis of the heavy thing. As described above, the X-coordinate and the Y-coordinate of the heavy thing and the X-coordinate and the Y-coordinate of the hoist are coincided with each other. Finally, the hoist motor of the hoist is operated to lower the hook down, and then, a heavy thing is hung on the hook, so that the heavy thing is at the ready for being transported. Such a heavy thing may be transported to a designated place in reverse order of the above-mentioned operation order.

Such a crane which is a heavy long loaded thing is difficult to be manufactured and requires lots of expenses, time and manpower in order to be transported. Therefore, the conventional crane is not easy in domestic transport and installation, and particularly, causes lots of barriers in trading among countries.

In order to export the cranes abroad, conventionally, people use a sea route, but it requires a great deal of time and shipping expenses and causes a damage of the crane.

That is, in order to transport the crane from a domestic manufacturing factory to a port, it is impossible to transport the crane by general transport, but the crane must be specially transported by a special transporting vehicle. Therefore, it requires a great deal of transporting expenses and time.

Moreover, the came specially transported to the port must be transported not by a general ship but by a special cargo ship, such as a bulk carrier. However, because such a special cargo ship runs irregularly, it is not easy to fix a transport date and it takes lots of transport costs.

Furthermore, the crane transported by the special cargo ship, such as the bulk carrier, must be transported to the designated place using a special transport vehicle from a port of a designated country, and hence, it also requires lots of transport costs and time.

The conventional method for transporting the crane has another problem in that some components of the crane are damaged by shock generated during transport. While the crane which is a heavy long loaded thing is transported by the land route and the sea route and while the crane is transshipped from the ground to the special transporting vehicle and from the special transporting vehicle to the special cargo ship, the crane is exposed to the outside, and hence, some components of the crane are damaged while being bumped.

The conventional method for transporting the crane has another problem in that the crane is not reusable after being disassembled. Because the conventional crane is heavy and very long and large, in fact, it is impossible to store it in safety after being disassembled. Therefore, for such reasons, in case that the crane is not needed, the expensive crane is abandoned as scrap metals after being disassembled.

### CITED REFERENCES

Korean Patent No. 10-0782566

### DISCLOSURE

### Technical Problem

Accordingly, the present invention has been made in an effort to solve the above-mentioned problems occurring in the prior arts, and it is an object of the present invention to provide a collapsible crane capable of being transported in a container which can be separately packed in a container of a predetermined standard by disassembling a girder into unit girders and collapsing components mounted on the unit girders.

### Technical Solution

To achieve the above objects, the present invention provides a collapsible crane capable of being transported in a container including: a girder which is a single body or is divided into several parts; saddles which is mounted at both end portions of the girder and which has wheels to be transported along rails so as to guide the crane to be transported in the back and forth direction along the rails, the saddles being respectively collapsed toward both end portions of the girder; an inspection deck which is mounted on the saddle to allow a worker to get on the inspection deck in order to inspect the wheels and which is conveyed toward the saddles when the saddles are collapsed toward the girder; a traveling current collecting bracket which is mounted on the inspection deck, which has a connector to which an external electric power is supplied, and which is collapsed toward the inner space of the inspection deck when the unit girder is accommodated in a container; a walk way hand rail which is mounted at one side of the girder in the longitudinal direction of the girder in order to guide the worker to inspect while moving in the longitudinal direction of the girder and which has an upper part which is collapsed toward the lower space of the inside thereof; a hoist which is mounted on the girder to be transported along the girder in the horizontal direction; a transverse current collecting bracket which is mounted on the hoist to guide a power line connected to the connector to be connected to the hoist and which is located above the girder by being collapsed in the horizontal direction when the unit girder is accommodated in the container; a hoist clamp which is mounted on the hoist and detachably mounted on the girder and which fixes the hoist to the girder by being fastened to the girder when the crane is transported; and carrying and packing parts which are connected to the divided unit girders in order to transport the girders from the manufacturing site to a transporting vehicle and from the transporting vehicle to an installation place.

In another aspect of the present invention, the present invention provides a collapsible crane capable of being transported in a container including a girder which is a heavy and long loaded thing, the girder including: a first girder which is located at the left side and has saddles mounted at both sides of an end portion, an inspection deck mounted on the saddle and a walk way hand rail mounted at one side of the girder in the longitudinal direction; a second girder which is located at the right side and has saddles mounted at both sides of an end portion, an inspection deck mounted on the saddle and a walk way hand rail mounted at one side of the girder in the longitudinal direction; and a third girder which is located at the center and has a hoist and a transverse current collecting bracket mounted on the hoist, wherein the first girder and the second girder are detachably connected to both ends of the third girder by means of flanges, and wherein components mounted on the first girder, the second girder and the third girder are collapsed to come into contact with the first girder, the second girder and the third girder and packed in a container.

Moreover, the girder includes: a first girder which is located at the left side and has a first flange formed on the circumference of one end portion; a second girder which is located at the right side and has a second flange formed on the circumference of one end portion; and a third girder which is located at the center and has third flanges formed on the circumferences of both end portions to correspond with the first flange and the second flange, wherein the girder is disassembled into the first girder, the second girder and the third girder when the crane is transported, and wherein the first flange and the second flange come into contact with the third flanges, and are fastened by girder bolts and girder nuts when the crane is assembled.

Furthermore, the saddles are respectively joined to saddle fixing parts fixed to both end portions of the girder by saddle rotating parts and are horizontally disposed to form a right angle to the girder, and are collapsed at front and rear sides of the girder to parallel with the longitudinal direction of the girder when the girder is disassembled and packed in the container.

Additionally, the saddle rotating part includes a hinge including: a first hinge fixed at an end portion of the saddle fixing part; a second hinge fixed at an end portion of the saddle corresponding to the end portion of the saddle fixing part; a hinge shaft hinge-coupled to the first hinge and the second hinge; and hinge fastening bolts fastened to the first hinge and the second hinge for restricting rotation of the saddles.

In addition, the inspection deck includes: a carriage which is mounted on the inner side of the saddle to allow the worker to get on the carriage; a telescoping bar of which one end is fixed to the saddle and of which the other end is fixed to the carriage, and which has a structure that a multistage tube type rod is collapsed in the longitudinal direction to thereby convey the carriage toward the saddle when the saddle is collapsed toward the girder; and a deck hand rail which is mounted on the carriage as a safety handrail for the worker and which is collapsed toward the inner space of the carriage when the carriage is conveyed toward the saddle because the telescoping bar is collapsed.

Moreover, the deck hand rail includes a rail bracket fixed at an end portion and a plurality of rail fastening bolts fastened to the rail bracket and the carriage, wherein just one rail fastening bolt which is the rotation center of the rail bracket and the deck hand rail keeps a temporarily assembled state and the remaining rail fastening bolts are separated, such that the rail bracket and the deck hand rail are rotated toward the inner space of the carriage.

Furthermore, the traveling current collecting bracket includes: a rotating bracket connected to the inspection deck; a connector supporting bar of which one end is fixed to the rotating bracket and of which the other end extends to the outside of the inspection deck and which has a connector; and a plurality of fastening bolts fastened to the inspection deck and the rotating bracket coming into contact with the inspection deck, wherein when the rotating bracket and the connector supporting bar are rotated toward the inner space of the inspection deck, just one fastening bolt which is the rotation center of the rotating bracket and the connector supporting bar keeps a temporarily assembled state and the remaining fastening bolts are separated, such that the rotating bracket and the connector supporting bar are rotated toward the inner space of the inspection deck, and wherein after being rotated, the separated fastening bolts are fastened to the rotating bracket and the inspection deck, so that the rotating bracket and the connector supporting bar which are rotated are fastened.

Additionally, the walk way hand rail includes: a lower fixing part of which one end is fixed to the girder to form an ambulatory passage for the worker; a foothold seated on the lower end portion of the lower fixing part; a hand rail part of which lower end is connected to the top of the lower fixing part to form the ambulatory passage for the worker together with the lower fixing part; and hand rail bolts fastened to the lower fixing part and the hand rail part, wherein just one hand rail bolt which is the rotation center of the hand rail part keeps a temporarily assembled state and the remaining hand rail bolts are separated, such that the hand rail part is rotated toward the inner space of the lower fixing part.

In addition, the transverse current collecting bracket includes: a guide bracket which is bent in the form of a ‘ [symbol] ’ shape, of which upper end portion is connected to the hoist, and which guides the external power supply to be connected to the hoist; a fastening piece which is fixed to the upper end portion of the guide bracket and is connected to the hoist; and a plurality of fastening bolts fastened to the fastening piece and the hoist, wherein just one fastening bolt which is the rotation center of the guide bracket and the fastening piece keeps a temporarily assembled state and the remaining fastening bolts are separated, such that the guide bracket and the fastening piece are rotated toward the second girder, and wherein after rotation, the separated fastening bolts are fastened to the fastening piece and the hoist, such that the rotated guide bracket and the rotated fastening piece are fixed to the hoist.

Furthermore, the crane further includes: power lines respectively mounted at the first girder, the second girder and the third girder to supply electric power to driving sources mounted on the unit girders; cable connectors which are connected to the power lines and are mounted at an end portion of the right side of the first girder, at an end portion of the left side of the second girder and at both end portions of the third girder, wherein the corresponding cable connectors are electrically connected with each other when the first flange of the first girder and the second flange of the second girder are connected to the third flanges of the third girder.

Additionally, the hoist clamp includes: an operation lever of which one end is rotatably connected to the hoist; a central shaft connected to the operation lever and the hoist and being a rotation center of the operation lever; and a detachable link of which one end is connected to the operation lever through a hinge shaft of which the other end is detachably mounted to the support jaw of the girder.

In addition, the carrying and packing part includes: a pipe of which both ends are fixed to the circumference of the through hole of the girder; a packing rod which is inserted into the pipe and of which both end portions are drawn out of the through hole of the girder; a base part for supporting the girder; a support plate connected to the upper face of the base part in such a manner that the girder is seated on the support plate; a support legs joined below the base part and supported on the floor; a detachable lever rotatably mounted on the base part; and a detachable link of which lower portion is hinge-coupled to the detachable lever and of which upper end portion is detachably mounted at both end portions of the packing rod.

### Advantageous Effects

According to the preferred embodiment of the present invention, the girder includes the first girder of the left side, the second girder of the right side and the third girder of the middle side, wherein the first girder and the second girder are detachably connected to the flanges of the both ends of the third girder, and the components mounted on the first girder, the second girder and the third girder are collapsed to come into contact with the first girder, the second girder and the third girder. Therefore, because the girder is separated into the first girder, the second girder and the third girder, and the components, such as the saddles, the inspection deck and the walk way hand rail, mounted on the first girder, the second girder and the third girder are collapsed toward the girders so as to come into contact with the girders, it minimizes the volume of the assembly of the first girder, the second girder and the third girder, so that the girders can be packed in the space of the standardized container by units. Therefore, because the crane which is heavy, long and large can be disassembled and collapsed and packed in the container by units, the crane can be transported by a general container without any special transporting vehicle not only in the land route but also in the sea route, thereby remarkably reducing transporting costs and the transporting period.

Moreover, because the separated unit girders and the components collapsed to the unit girders are packed in the container by units, the components of the crane are not exposed to the outside, the crane is not damaged while the crane packed in the container by units is transported in the land route and in the sea route and while the crane is transshipped from the ground to the general transporting vehicle and from the general transporting vehicle to the general cargo ship.

Furthermore, the collapsible crane capable of being transported in the container according to the preferred embodiment of the present invention is packed and transported in the container during land transportation and marine transportation because it can be packed in the container even though it is a heavy and long loaded thing, thereby being transported with the minimum costs, time and manpower. Additionally, such packing and transporting can activate not only the domestic crane industry but also the crane trade among countries.

The collapsible crane capable of being transported in the container according to the preferred embodiment of the present invention can be easily disassembled and stored after being used. After the crane is disassembled into the first girder, the second girder and the third girder and the components mounted on the girders are collapsed, when the girders are packed in the container by units, the crane can be stored for a long time without being exposed to the outside. Therefore, in case that the crane is not needed, because the crane can be stored in safety after being disassembled, there is no need to abandon the expensive crane as scrap metals, and the crane according to the preferred embodiment of the present invention can remarkably reduce financial burdens because it is reusable after being stored as needed.

### DESCRIPTION OF DRAWINGS

FIG. 1 is a schematic perspective view of a collapsible crane capable of being transported in a container according to a preferred embodiment of the present invention.

FIG. 2 is a perspective view showing essential parts of a first girder.

FIG. 3 is a perspective view showing essential parts of a second girder.

FIG. 4 is a perspective view showing essential parts of a third girder.

FIG. 5 is a plan view showing a separated state of the first girder, the second girder and the third girder.

FIG. 6 shows a perspective view, a front view, a side view and a plan view showing a state where a saddle mounted on the first girder is collapsed toward the first girder.

FIG. 7 shows a front view, a side view and a plan view showing a state where a saddle mounted on the second girder is collapsed toward the second girder.

FIG. 8 shows front views and plan views showing an inspection deck and a collapsed state of the inspection deck.

FIG. 9 is a front view showing a collapsed state of a deck hand rail.

FIG. 10 is a schematic plan view showing a collapsed state of a traveling current collecting bracket.

FIG. 11 is a perspective view showing a collapsed state of a transverse current collecting bracket.

FIG. 12 is a side view showing a collapsed state of a walk way hand rail.

FIG. 13 shows a front view, a side view and a partially enlarged view of a hoist clamp.

FIG. 14 shows a front view and a side view showing a state where a carrying and packing part is mounted on the first girder.

FIG. 15 shows a front view, a side view and a plan view of the carrying and packing part.

FIG. 16 is a front view showing a transported state of the assembled girder.

FIG. 17 shows schematic plan views showing a state where the first girder and the second girder are packed in one container and the third girder is packed in another container.

### MODE FOR INVENTION

Reference will be now made in detail to the preferred embodiment of the present invention with reference to the attached drawings.

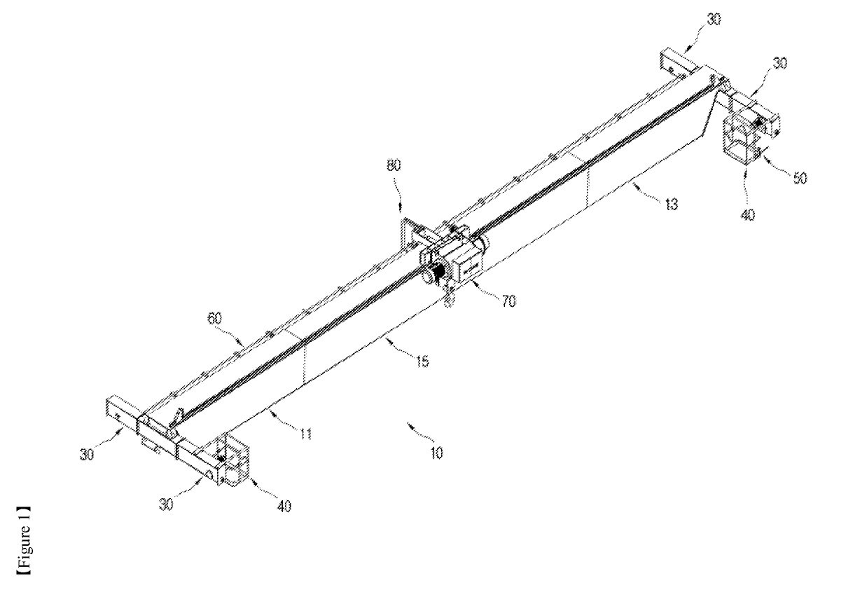

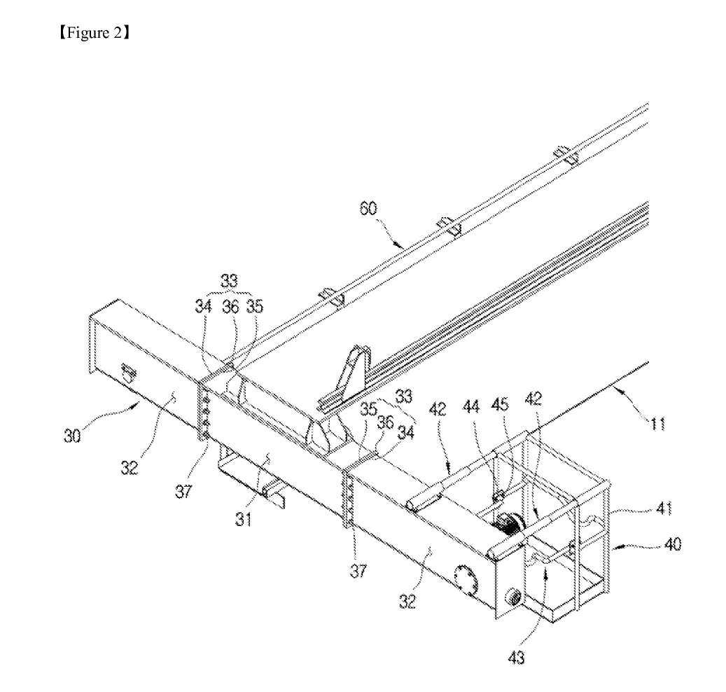

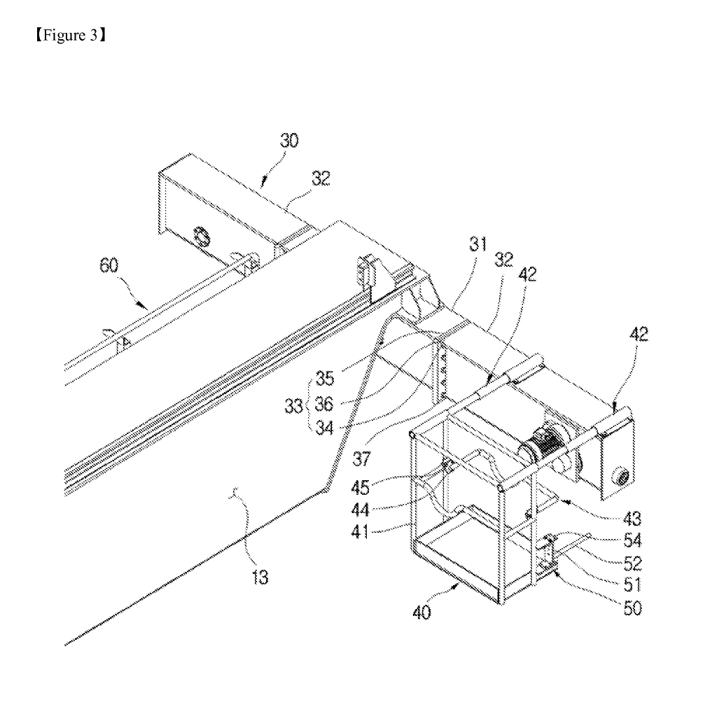

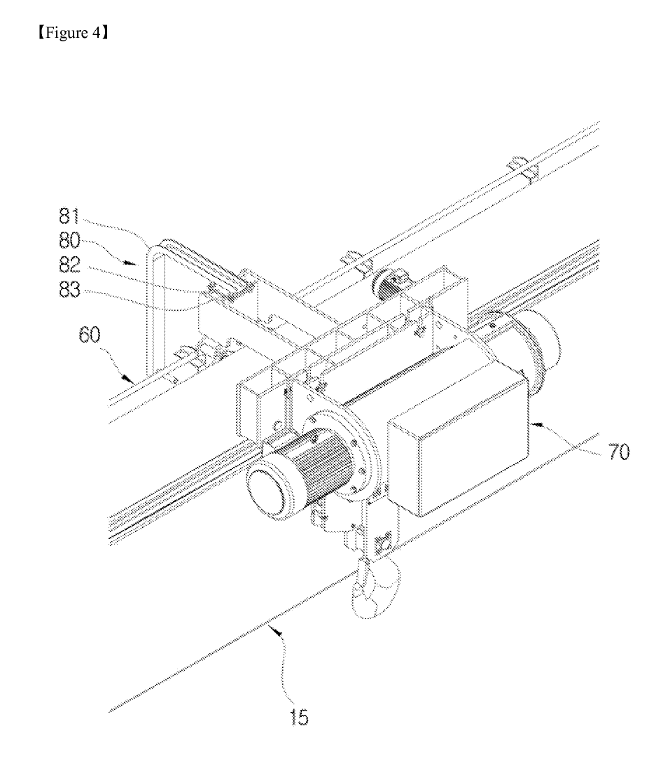

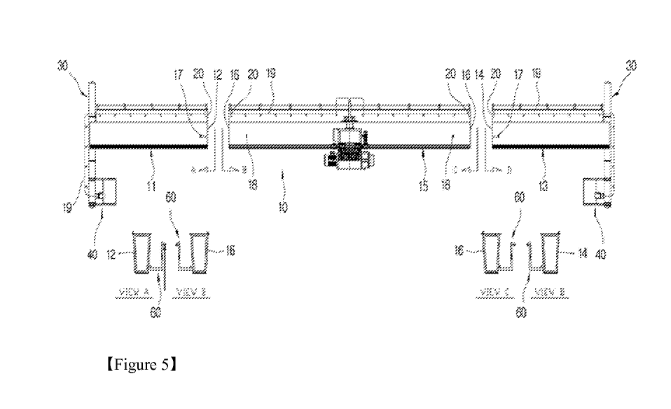

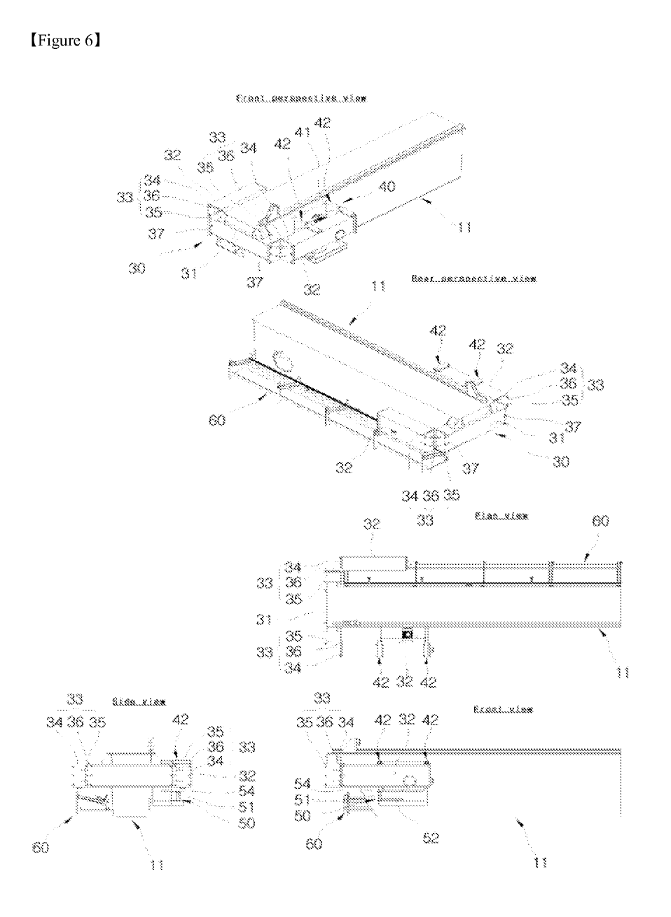

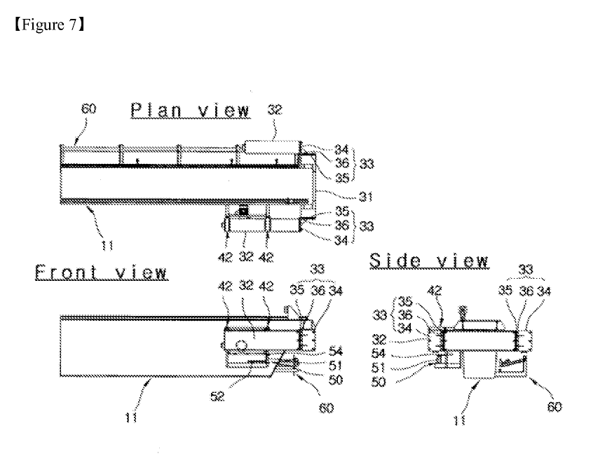

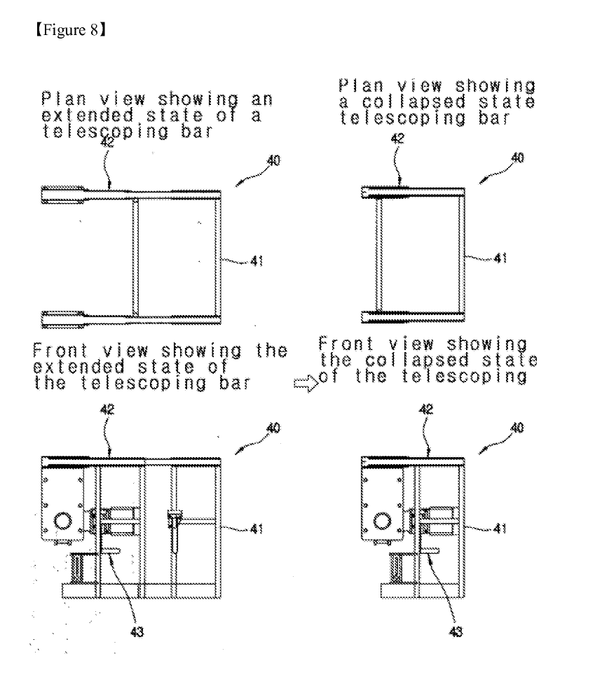

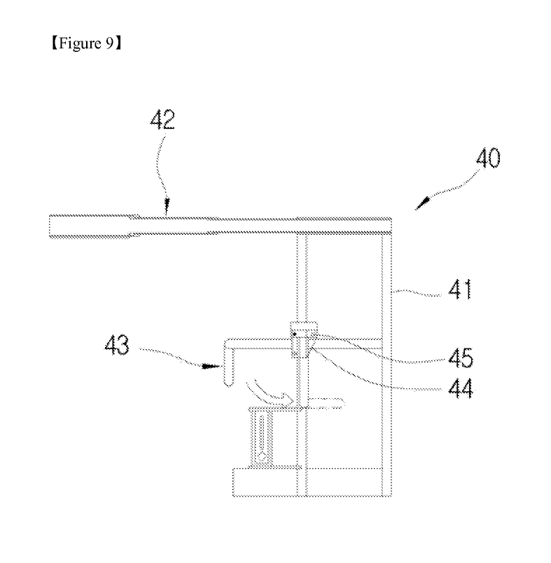

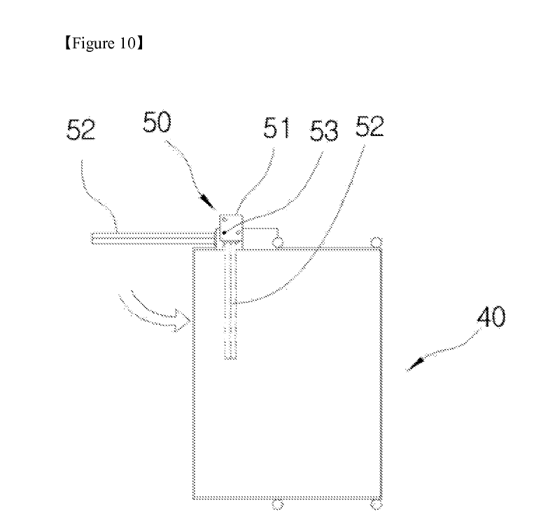

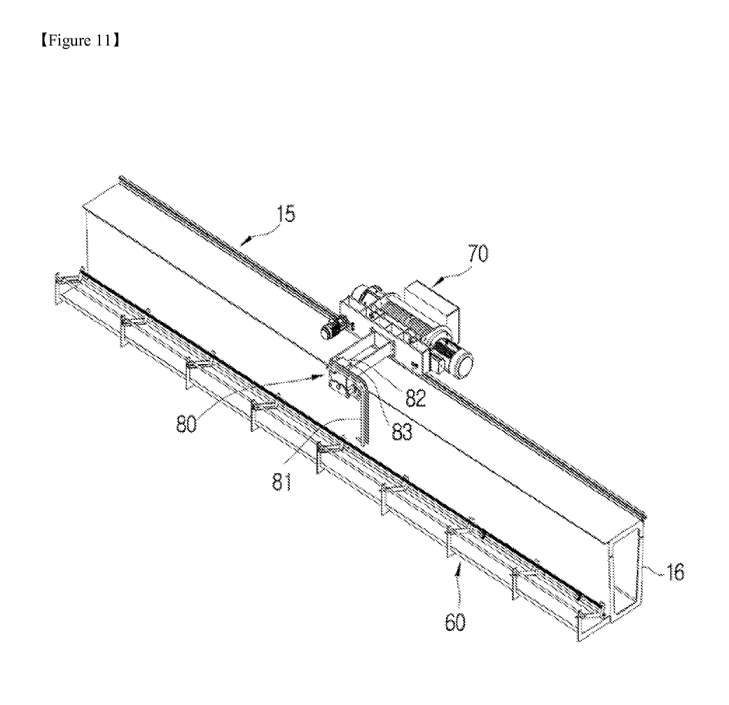

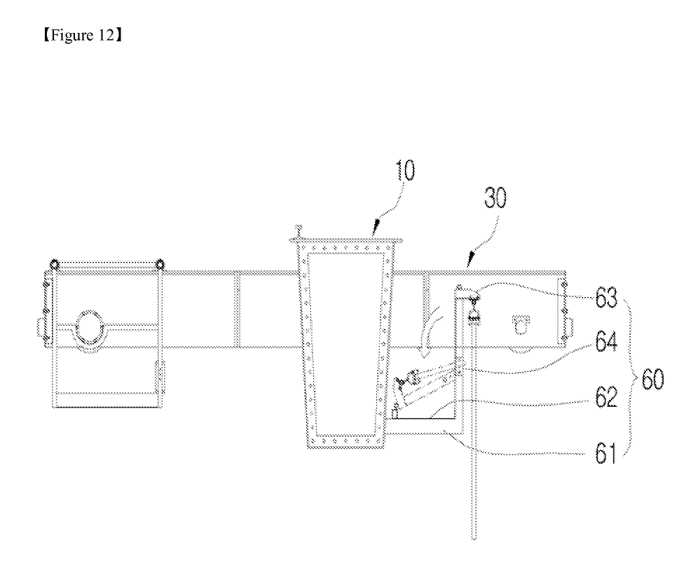

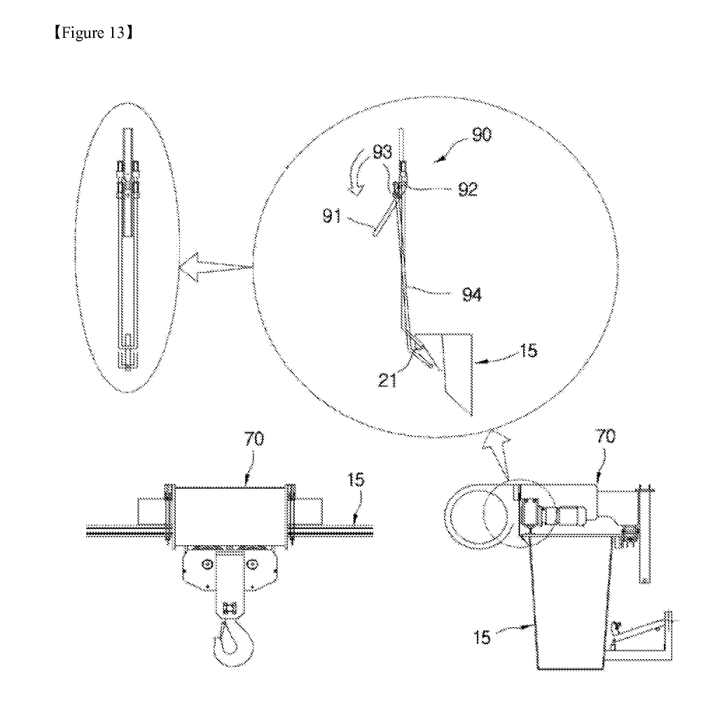

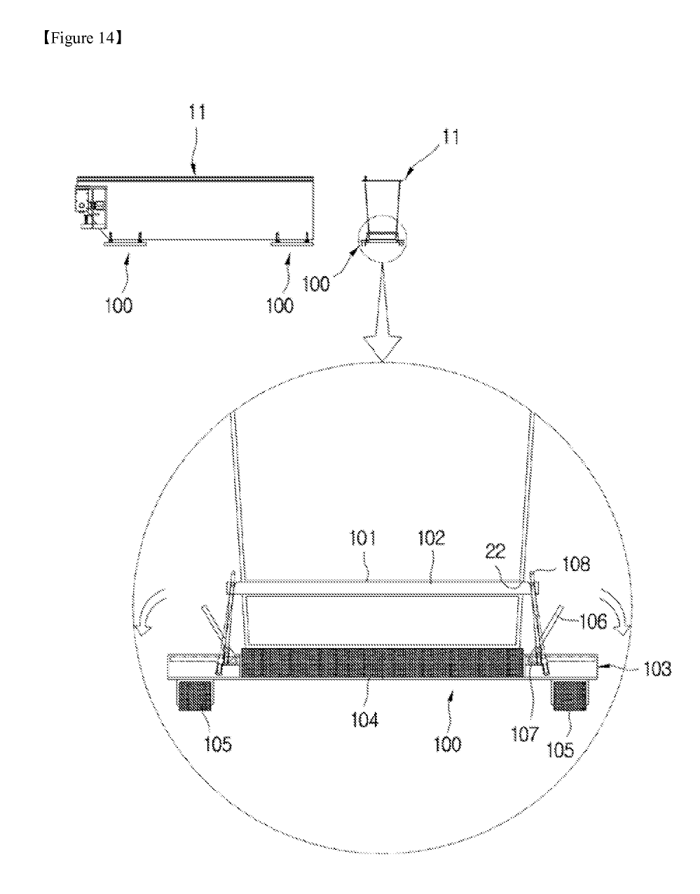

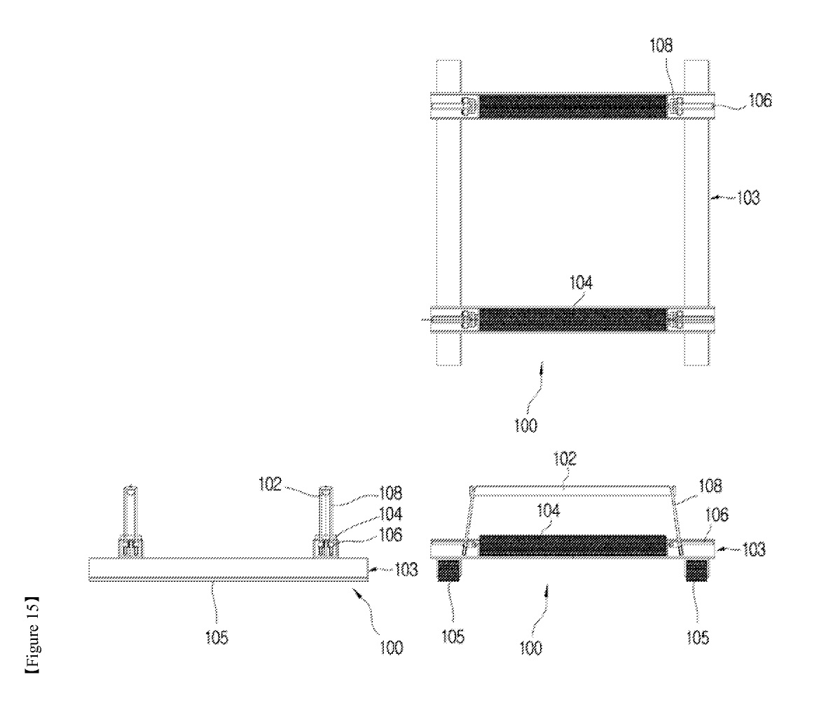

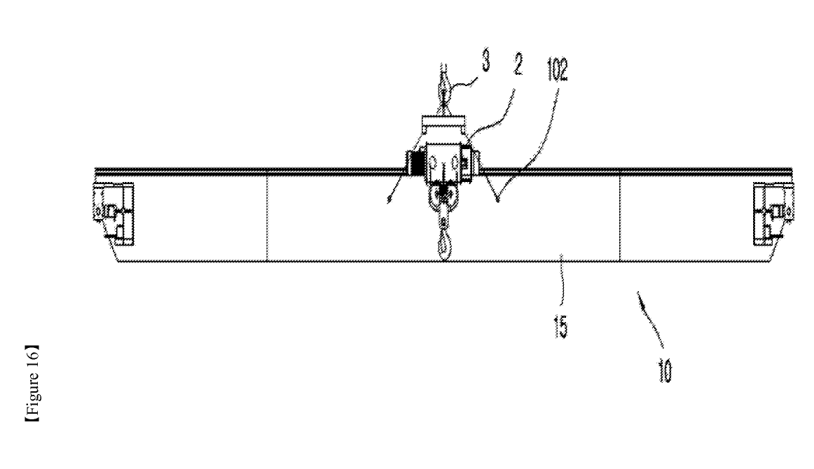

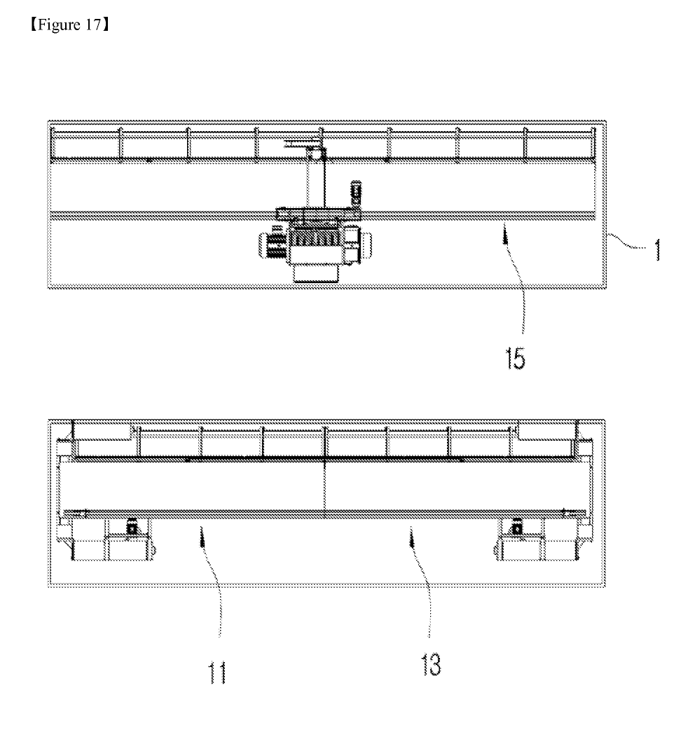

FIG. 1 is a schematic perspective view of a collapsible crane capable of being transported in a container according to a preferred embodiment of the present invention, FIG. 2 is a perspective view showing essential parts of a first girder, FIG. 3 is a perspective view showing essential parts of a second girder, FIG. 4 is a perspective view showing essential parts of a third girder, FIG. 5 is a plan view showing a separated state of the first girder, the second girder and the third girder, FIG. 6 shows a perspective view, a front view, a side view and a plan view showing a state where a saddle mounted on the first girder is collapsed toward the first girder, FIG. 7 shows a front view, a side view and a plan view showing a state where a saddle mounted on the second girder is collapsed toward the second girder, FIG. 8 shows front views and plan views showing an inspection deck and a collapsed state of the inspection deck, FIG. 9 is a front view showing a collapsed state of a deck hand rail, FIG. 10 is a schematic plan view showing a collapsed state of a traveling current collecting bracket, FIG. 11 is a perspective view showing a collapsed state of a transverse current collecting bracket, FIG. 12 is a side view showing a collapsed state of a walk way hand rail, FIG. 13 shows a front view, a side view and a partially enlarged view of a hoist clamp, FIG. 14 shows a front view and a side view showing a state where a carrying and packing part is mounted on the first girder, FIG. 15 shows a front view, a side view and a plan view of the carrying and packing part, FIG. 16 is a front view showing a transported state of the assembled girder, and FIG. 17 shows schematic plan views showing a state where the first girder and the second girder are packed in one container and the third girder is packed in another container.

The collapsible crane capable of being transported in a container according to the preferred embodiment of the present invention includes a girder 10 which is a heavy long loaded thing, and the girder 10 includes: a first girder 11 which is located at the left side and has saddles 30 mounted at both sides of an end portion, an inspection deck 40 mounted on the saddle 30 and a walk way hand rail 60 mounted at one side of the girder 10 in the longitudinal direction; a second girder 13 which is located at the right side and has saddles 30 mounted at both sides of an end portion, an inspection deck 40 mounted on the saddle 30 and a walk way hand rail 60 mounted at one side of the girder 10 in the longitudinal direction; and a third girder 15 which is located at the center and has a hoist 70 and a transverse current collecting bracket 80 mounted on the hoist 70.

The first girder 11 and the second girder 13 are detachably connected to both ends of the third girder 15 by means of flanges, and components mounted on the first girder 11, the second girder 13 and the third girder 15 are collapsed to come into contact with the first girder 11, the second girder 13 and the third girder 15 and packed in a container 1.

Such a collapsible crane capable of being transported in a container according to the preferred embodiment of the present invention includes the girder 10, the saddles 30, the inspection deck 40, the travelling current collecting bracket 50, the walk way hand rail 60, the hoist 70, the transverse current collecting bracket 80, a hoist clamp 90, and a carrying and packing part 100.

The girder 10 may be a single body or may be divided into a plurality of parts.

As shown in FIGS. 1 to 7, the girder 10 includes a first girder 11 which is located at the left side and has a first flange 12 formed on the circumference of one end portion; a second girder 13 which is located at the right side and has a second flange 14 formed on the circumference of one end portion; and a third girder 15 which is located at the center and has third flanges 16 formed on the circumferences of both end portions to correspond with the first flange 12 and the second flange 14.

The girder 10 is disassembled into the first girder 11, the second girder 13 and the third girder 15 when it is packed in the container 1 to be transported or stored. However, in order to assemble the girder 10, the first flange 12 and the second flange 14 come into contact with the third flange 16, and then, are fastened by girder bolts 17 and girder nuts 18.

As shown in FIG. 13, the second girder 13 has a support jaw 21 for supporting a detachable link 94 of a hoist clamp 90 which will be described later.

Furthermore, as shown in FIG. 14, the first girder 11 has a through hole 22 through which a pipe 101 of a carrying and packing part 100 is inserted and supported. Besides the first girder 11, the second girder 13 and the third girder 15 also respectively have through holes 22, and so, the carrying and packing parts 100 which will be described later are also mounted in the second girder 13 and the third girder 15 in the same structure.

The first girder 11, the second girder 13 and the third girder 15 respectively have power lines 19 for supplying electric power to driving sources mounted on the unit girders 10.

Additionally, cable connectors 20 are mounted at an end portion of the right side of the first girder 11, at an end portion of the left side of the second girder 13 and at both end portions of the third girder 15, and the power lines 19 are respectively connected to the cable connectors 20. Therefore, when the first flange 12 of the first girder 11 and the second flange 14 of the second girder 13 are connected to the third flanges 16 of the third girder 15, the corresponding cable connectors 20 are electrically connected with each other.

As shown in FIGS. 1 to 3 and 5 to 7, the saddles 30 are mounted at both end portions of the girder 10 and have wheels to be conveyed along rails so that the crane is guided to be transported in the back and forth direction along the rails. The saddles 30 are respectively collapsed at both end portions of the girder 10.

The saddles 30 are respectively joined to saddle fixing parts 31 fixed to both end portions of the girder 10 by saddle rotating parts 32, and are horizontally disposed to form a right angle to the girder 10, and are collapsed at front and rear sides of the girder 10 to parallel with the longitudinal direction of the girder 10 when the girder 10 is disassembled and packed in the container 1.

The saddle rotating part 32 includes a hinge 33 having: a first hinge 34 fixed at an end portion of the saddle fixing part 31; a second hinge 35 fixed at an end portion of the saddle 30 corresponding to the end portion of the saddle fixing part 31; and a hinge shaft 36 hinge-coupled to the first hinge 34 and the second hinge 35. Moreover, hinge fastening bolts 37 for restricting rotation of the saddle 30 are fastened to the first hinge 34 and the second hinge 35.

As shown in FIGS. 1 to 3 and 5 to 8, the inspection deck 40 is mounted on the saddle 30 to allow a worker to get on the inspection deck 40 in order to inspect the wheels, and is conveyed toward the saddles 30 when the saddles 30 are collapsed toward the girder 10. The inspection deck 40 includes a carriage 41, a telescoping bar 42 and a deck hand rail 43.

The carriage 41 is mounted on the inner side of the saddle 30 to allow the worker to get on the carriage 41.

The telescoping bar 42 has one end fixed to the saddle 30 and the other end fixed to the carriage 41, and has a structure that a multistage tube type rod is collapsed in the longitudinal direction to thereby convey the carriage 41 toward the saddle when the saddle 30 is collapsed toward the girder 10.

The deck hand rail 43 is mounted on the carriage 41 as a safety handrail for the worker and is collapsed toward the inner space of the carriage 41 when the carriage 41 is conveyed toward the saddle 30 because the telescoping bar 42 is collapsed.

The deck hand rail 43 includes a rail bracket 44 fixed at an end portion, and a plurality of rail fastening bolts 45 are fastened to the rail bracket 44 and the carriage 41.

Just one rail fastening bolt 45 which is the rotation center of the rail bracket 44 and the deck hand rail 43 keeps a temporarily assembled state and the remaining rail fastening bolts 45 are separated, such that the rail bracket 44 and the deck hand rail 43 are rotated toward the inner space of the carriage 41.

As shown in FIGS. 1 and 3, the traveling current collecting bracket 50 is mounted on the inspection deck 40, has a connector for supplying an external power supply, and is collapsed toward the inner space of the inspection deck 40 when the unit girders 10 are accommodated in the container 1.

The traveling current collecting bracket 50 includes: a rotating bracket 51 connected to the inspection deck 40; a connector supporting bar 52 of which one end is fixed to the rotating bracket 51 and of which the other end extends to the outside of the inspection deck 40 and which has a connector; and a plurality of fastening bolts 53 fastened to the inspection deck 40 and the rotating bracket 51 coming into contact with the inspection deck 40.

Just one fastening bolt 53 which is the rotation center of the rotating bracket 51 and the connector supporting bar 52 keeps a temporarily assembled state and the remaining fastening bolts 53 are separated, such that the rotating bracket 51 and the connector supporting bar 52 are rotated toward the inner space of the inspection deck 40.

After the traveling current collecting bracket 50 is rotated, the separated fastening bolts 53 are fastened to the rotating bracket 51 and the inspection deck 40, so that the rotating bracket 51 and the connector supporting bar 52 which are rotated are fastened.

The walk way hand rail 60 is mounted at one side of the girder in the longitudinal direction of the girder 10 in order to guide the worker to inspect while moving in the longitudinal direction of the girder 10, and has an upper part which is collapsed toward the lower space of the inside thereof.

As shown in FIGS. 1, 5 to 7, 11 and 12, the walk way hand rail 60 includes: a lower fixing part 61 of which one end is fixed to the girder 10 to form an ambulatory passage for the worker; a foothold 62 seated on the lower end portion of the lower fixing part 61; a hand rail part of which lower end is connected to the top of the lower fixing part 61 to form the ambulatory passage for the worker together with the lower fixing part 61; and hand rail bolts 64 fastened to the lower fixing part 61 and the hand rail part 63.

Just one hand rail bolt 64 which is the rotation center of the hand rail part 63 keeps a temporarily assembled state and the remaining hand rail bolts 64 are separated, such that the hand rail part 63 is rotated toward the inner space of the lower fixing part 61.

As shown in FIGS. 1, 4 and 5, the hoist 70 is mounted on the girder 10 to be conveyed in the horizontal direction along the girder 10.

The transverse current collecting bracket 80 is mounted on the hoist 70 to guide the power line 19 connected to the connector to be connected to the hoist 70, and is located above the girder 10 by being collapsed in the horizontal direction when the unit girder 10 is accommodated in the container 1.

As shown in FIGS. 1, 4, 5 and 11, the transverse current collecting bracket 80 includes: a guide bracket 81 which is bent in the form of a ‘ [symbol] ’ shape, of which upper end portion is connected to the hoist 70, and which guides the external power supply to be connected to the hoist 70; a fastening piece 82 which is fixed to the upper end portion of the guide bracket 81 and is connected to the hoist 70; and a plurality of fastening bolts 83 fastened to the fastening piece 82 and the hoist 70.

When the guide bracket 81 and the fastening piece 82 of the transverse current collecting bracket 80 are rotated toward the second girder 13, just one fastening bolt 83 which is the rotation center of the guide bracket 81 and the fastening piece 82 keeps a temporarily assembled state and the remaining fastening bolts 83 are separated, such that the guide bracket 81 is rotated toward the second girder 13.

After the transverse current collecting bracket 80 is rotated, the separated fastening bolts 83 are fastened to the fastening piece 82 and the hoist 70, such that the rotated guide bracket 81 and the rotated fastening piece 82 are fixed to the hoist 70.

The hoist clamp 90 is mounted on the hoist 70, and is detachably mounted on the girder 10, and is connected to the girder 10 when the crane is transported, such that the hoist 70 is fixed to the girder 10.

As shown in FIG. 13, the hoist clamp 90 includes: an operation lever 91 of which one end is rotatably connected to the hoist 70; a central shaft 92 connected to the operation lever 91 and the hoist 70 and being a rotation center of the operation lever 91; and a detachable link 94 of which one end is connected to the operation lever 91 through a hinge shaft 93 of which the other end is detachably mounted to the support jaw 21 of the girder 10.

The carrying and packing parts 100 are connected to the divided unit girders 10 in order to transport the girders 10 from the manufacturing site to a transporting vehicle and from the transporting vehicle to an installation place.

As shown in FIGS. 14 and 15, the carrying and packing part 100 includes: a pipe 101 of which both ends are fixed to the circumference of the through hole 22 of the girder 10; a packing rod 102 which is inserted into the pipe 101 and of which both end portions are drawn out of the through hole 22 of the girder 10; a base part 103 for supporting the girder 10; a support plate 104 connected to the upper face of the base part 103 in such a manner that the girder 10 is seated on the support plate 104; a support legs 105 joined below the base part 103 and supported on the floor; a detachable lever 106 rotatably mounted on the base part 103; and a detachable link 108 of which lower portion is hinge-coupled to the detachable lever 106 and of which upper end portion is detachably mounted at both end portions of the packing rod 102.

Therefore, the base part 103 is supported below the first girder 11 and the packing rod 102 is fit into the first girder 11, and then, the detachable link 108 is fastened to the girder 11, such that packing for carrying is completed simply.

The collapsible crane capable of being transported by the container according to the preferred embodiment of the present invention is packed in the container 1 after being disassembled as follows.

In order to pack the crane, which is a heavy long loaded thing, as shown in FIG. 1, the girder bolts 17 and the girder nuts 18 fastened to the first flange 12 of the first girder 11 and the third flange 16 of the third girder 15 are released. After that, the girder bolts 17 and the girder nuts 18 fastened to the second flange 14 of the second girder 13 and the third flange 16 of the third girder 15 are released.

When the girder 10 is divided into three equal parts, namely, the first girder 11, the second girder 13 and the third girder 15, the components mounted on the girder 10 are collapsed.

First, the deck hand rail 43 and the traveling current collecting bracket 50 are folded toward the inner space of the inspection deck. In order to fold the deck hand rail 43, except the one rail fastening bolt 45 which is the rotation center of the deck hand rail 43, the remaining rail fastening bolts 45 are released. After that, the deck hand rail 43 is rotated around the fastened rail fastening bolt 45 so as to be collapsed toward the inner space of the inspection deck 40.

When the deck hand rail 43 is collapsed, except the one fastening bolt 53 which is the rotation center of the traveling current collecting bracket 50, the remaining fastening bolts 53 are released. After that, the traveling current collecting bracket 50 is rotated around the fastened fastening bolt 53 so as to be collapsed toward the inner space of the inspection deck 40.

When the deck hand rail 43 and the traveling current collecting bracket 50 are collapsed, the inspection deck 40 mounted on the first girder 11 and the second girder 13 is pushed toward the first girder 11 and the second girder 13, such that the telescoping bar 42 is folded to thereby minimize the space of the inspection deck.

Next, the hand rail part 63 of the walk way hand rail 60 is folded toward the inside of the lower fixing part 61. Except the one hand rail bolt 64 which is the rotation center of the hand rail part 63, the remaining hand rail bolts 64 are released. After that, the hand rail part 63 is rotated to be collapsed toward the inside of the lower fixing part 61.

When the hand rail part 63 is collapsed, the transverse current collecting bracket 80 is folded. Except the one fastening bolt 83 which is the rotation center of the transverse current collecting bracket 80, the remaining fastening bolts 83 are released. After that, the transverse current collecting bracket 80 is rotated in the horizontal direction so as to be in contact with the third girder 15.

When the transverse current collecting bracket 80 is collapsed, the saddles 30 mounted at both ends of the first girder 11 and the second girder 13 are collapsed toward the first girder 11 and the second girder 13. In order to collapse the saddles 30, the hinge fastening bolts 37 are released from the hinges 33 so that the hinges 33 are freely rotated, and in the above state, the saddles 30 are collapsed toward the first girder 11 and the second girder 13.

Furthermore, the hoist 70 is fixed to the third girder 15 using the hoist clamp 90. In this instance, when the lower end portion of the detachable link 94 is retained to the support jaw 21 and the operation lever 91 is pushed toward the upside, the detachable link 94 is pulled upward and is supported to the support jaw 21.

Then, the first girder 11, the second girder 13 and the third girder 15 are separated from each other and the components mounted on the girders are collapsed and fastened, and after that, the carrying and packing parts 100 are mounted to convey the first girder 11, the second girder 13 and the third girder 15 which are separated from each other.

The first girder 11 is seated on the support plate 104 of the base part 103, the packing rod 102 is fit to the pipe 101 of the first girder 11, and then, the upper end portions of the detachable links 108 are located at both ends of the packing rod 102. Furthermore, the upper end of the detachable lever 106 is pushed down, so that the upper end portions of the detachable links 108 are supported to both end portions of the packing rod 102. Through the above method, the carrying and packing parts 100 are simply mounted at the first girder 11, the second girder 13 and the third girder 15.

FIG. 16 is a front view showing a conveyed state of the assembled girder 10. The entire of the assembled girder 10 can be easily conveyed using the pipe 101 and the packing rod 102 of the carrying and packing part 100. That is, when a wire rope 2 is connected to the end portion of the packing rod 102 mounted on the second girder 13 and a hook 3 is retained to the wire rope 2, the girder 10 can be easily conveyed.

Conventionally, in order to pack and convey the girder, the lower support plate and the upper support plate are respectively located at the lower part and the upper part of the girder and the girder, the lower support plate and the upper support plate are surrounded by a rope to be packed, and hence, the packing work is very complicated. On the contrary, the packing and conveying method according to the preferred embodiment of the present invention is very convenient in packing and lifting the girder because the wire rope is connected to the packing rod 102 and the hook 3 is retained to the wire rope 2 after the packing rod 102 is fit to the third girder 15.

FIG. 17 shows schematic plan views showing a state where the first girder 11 and the second girder 13 are packed in one container 1 and the third girder 15 is packed in another container 1.

After the girder 10 is separated into the first girder 11, the second girder 13 and the third girder 15 and the components mounted on the girders 10 are collapsed, the girders are packed in the container 1. Because the length of the third girder 15 is equal to or similar to the sum of the lengths of the first girder 11 and the second girder 13, after the first girder 11 and the second girder 13 are arranged in a line, they are packed in one container 1, and then, the third girder 15 is separately packed in another container 1.

As described above, the collapsible crane capable of being transported by the container according to the preferred embodiment of the present invention has the following merits.

First, the girder 10 includes the first girder 11 of the left side, the second girder 13 of the right side and the third girder 15 of the middle side, and the first girder 11 and the second girder 13 are detachably connected to the flanges of the both ends of the third girder 15, and the components mounted on the first girder 11, the second girder 13 and the third girder 15 are collapsed to come into contact with the first girder 11, the second girder 13 and the third girder 15.

Therefore, because the girder 10 is separated into the first girder 11, the second girder 13 and the third girder 15, and the components, such as the saddles 30, the inspection deck 40 and the walk way hand rail 60, mounted on the first girder 11, the second girder 13 and the third girder 15 are collapsed toward the girders 10 so as to come into contact with the girders 10, it minimizes the volume of the assembly of the first girder 11, the second girder 13 and the third girder 15, so that the girders can be packed in the space of the standardized container 1 by units as shown in FIG. 16. The first girder 11 and the second girder 13 are accommodated and packed in one container 1, and the third girder 15 which is longer than the first and second girders 11 and 13 is accommodated and packed in another container 1.

Therefore, because the crane which is heavy, long and large can be disassembled and collapsed and packed in the container 1 by units, the crane can be transported by a general container 1 without any special transporting vehicle not only in the land route but also in the sea route, thereby remarkably reducing transporting costs and the transporting period.

Second, because the separated unit girders 10 and the components collapsed to the unit girders 10 are packed in the container 1 by units, the components of the crane are not exposed to the outside and accordingly there is almost never the risk of damage of the crane while the crane packed in the container 1 by units is transported in the land route and in the sea route and while the crane is transshipped from the ground to the general transporting vehicle and from the general transporting vehicle to the general cargo ship.

Third, the collapsible crane capable of being transported by the container according to the preferred embodiment of the present invention is packed and transported in the container 1 during land transportation and marine transportation because it can be packed in the container 1 even though it is a heavy and long loaded thing, thereby being transported with the minimum costs, time and manpower. Additionally, such packing and transporting can activate not only the domestic crane industry but also the crane trade among countries.

Fourth, the collapsible crane capable of being transported by the container according to the preferred embodiment of the present invention can be easily disassembled and stored after being used. After the crane is disassembled into the first girder 11, the second girder 13 and the third girder 15 and the components mounted on the girders are collapsed, when the girders are packed in the container 1 by units, the crane can be stored for a long time without being exposed to the outside.

Therefore, in case that the crane is not needed, because the crane can be stored in safety after being disassembled, there is no need to abandon the expensive crane as scrap metals, and the crane according to the preferred embodiment of the present invention can remarkably reduce financial burdens because it is reusable after being stored as needed.

Fifth, according to the present invention, when a detachable links 94 are fastened to the girders after the support plate 104 of the base part 103 is supported below the first girder 11, the second girder 13 and the third girder 15 and the packing rod 102 is fit to the first girder 11, the second girder 13 and the third girder 15, packing for transporting the girders 10 is completed.

Therefore, the packing work for transporting the girders 10 becomes very simplified, and hence, it can reduce the packing period and worker's fatigue.

1. A crane collapsible crane capable of being transported by a container comprising:
a girder which is a single body or is divided into several parts;
saddles which are mounted at both end portions of the girder and which have wheels to be transported along rails so as to guide the crane to be transported in the back and forth direction along the rails, the saddles being respectively collapsed toward both end portions of the girder;
an inspection deck which is mounted on the saddle to allow a worker to get on the inspection deck in order to inspect the wheels and which is conveyed toward the saddles when the saddles are collapsed toward the girder;
a traveling current collecting bracket which is mounted on the inspection deck, which has a connector to which an external electric power is supplied, and which is collapsed toward the inner space of the inspection deck when the unit girder is accommodated in a container;
a walk way hand rail which is mounted at one side of the girder in the longitudinal direction of the girder in order to guide the worker to inspect while moving in the longitudinal direction of the girder and which has an upper part which is collapsed toward the lower space of the inside thereof;
a hoist which is mounted on the girder to be transported along the girder in the horizontal direction;
a transverse current collecting bracket which is mounted on the hoist to guide a power line connected to the connector to be connected to the hoist and which is located above the girder by being collapsed in the horizontal direction when the unit girder is accommodated in the container;
a hoist clamp which is mounted on the hoist and detachably mounted on the girder and which fixes the hoist to the girder by being fastened to the girder when the crane is transported; and
carrying and packing parts which are connected to the divided unit girders in order to transport the girders from the manufacturing site to a transporting vehicle and from the transporting vehicle to an installation place.

2. A crane collapsible crane capable of being transported by a container comprising a girder which is a heavy and long loaded thing, the girder comprising: a first girder which is located at the left side and has saddles mounted at both sides of an end portion, an inspection deck mounted on the saddle and a walk way hand rail mounted at one side of the girder in the longitudinal direction; a second girder which is located at the right side and has saddles mounted at both sides of an end portion, an inspection deck mounted on the saddle and a walk way hand rail mounted at one side of the girder in the longitudinal direction; and a third girder which is located at the center and has a hoist and a transverse current collecting bracket mounted on the hoist,
wherein the first girder and the second girder are detachably connected to both ends of the third girder by means of flanges, and
wherein components mounted on the first girder, the second girder and the third girder are collapsed to come into contact with the first girder, the second girder and the third girder and packed in a container.

3. The crane according to claim 1, wherein the girder comprises:
a first girder which is located at the left side and has a first flange formed on the circumference of one end portion; a second girder which is located at the right side and has a second flange formed on the circumference of one end portion; and a third girder which is located at the center and has third flanges formed on the circumferences of both end portions to correspond with the first flange and the second flange,
wherein the girder is disassembled into the first girder, the second girder and the third girder when the crane is transported; and wherein the first flange and the second flange come into contact with the third flanges, and are fastened by girder bolts and girder nuts.

4. The crane according to claim 1, wherein the saddles are respectively joined to saddle fixing parts fixed to both end portions of the girder by saddle rotating parts, are horizontally formed at right angles to the girder, and are collapsed at front and rear sides of the girder to parallel with the longitudinal direction of the girder when the girder is disassembled and packed in the container.

5. The crane according to claim 4, wherein the saddle rotating part comprises a hinge including: a first hinge fixed at an end portion of the saddle fixing part; a second hinge fixed at an end portion of the saddle corresponding to the end portion of the saddle fixing part; a hinge shaft hinge-coupled to the first hinge and the second hinge; and hinge fastening bolts fastened to the first hinge and the second hinge for restricting rotation of the saddles.

6. The crane according to claim 1, wherein the inspection deck comprises:
a carriage which is mounted on the inner side of the saddle to allow the worker to get on the carriage;
a telescoping bar of which one end is fixed to the saddle and of which the other end is fixed to the carriage, and which has a structure that a multistage tube type rod is collapsed in the longitudinal direction to thereby convey the carriage toward the saddle when the saddle is collapsed toward the girder; and
a deck hand rail which is mounted on the carriage as a safety handrail for the worker and which is collapsed toward the inner space of the carriage when the carriage is conveyed toward the saddle because the telescoping bar is collapsed.

7. The crane according to claim 6, wherein the deck hand rail comprises a rail bracket fixed at an end portion and a plurality of rail fastening bolts fastened to the rail bracket and the carriage,
wherein just one rail fastening bolt which is the rotation center of the rail bracket and the deck hand rail keeps a temporarily assembled state and the remaining rail fastening bolts are separated, such that the rail bracket and the deck hand rail are rotated toward the inner space of the carriage.

8. The crane according to claim 1, wherein the traveling current collecting bracket comprises: a rotating bracket connected to the inspection deck a connector supporting bar of which one end is fixed to the rotating bracket and of which the other end extends to the outside of the inspection deck and which has a connector; and a plurality of fastening bolts fastened to the inspection deck and the rotating bracket coming into contact with the inspection deck,
wherein when the rotating bracket and the connector supporting bar are rotated toward the inner space of the inspection deck, just one fastening bolt which is the rotation center of the rotating bracket and the connector supporting bar keeps a temporarily assembled state and the remaining fastening bolts are separated, such that the rotating bracket and the connector supporting bar are rotated toward the inner space of the inspection deck, and
wherein after being rotated, the separated fastening bolts are fastened to the rotating bracket and the inspection deck, so that the rotating bracket and the connector supporting bar which are rotated are fastened.

9. The crane according to claim 1, wherein the walk way hand rail comprises: a lower fixing part of which one end is fixed to the girder to form an ambulatory passage for the worker; a foothold seated on the lower end portion of the lower fixing part; a hand rail part of which lower end is connected to the top of the lower fixing part to form the ambulatory passage for the worker together with the lower fixing part; and hand rail bolts fastened to the lower fixing part and the hand rail part,
wherein just one hand rail bolt which is the rotation center of the hand rail part keeps a temporarily assembled state and the remaining hand rail bolts are separated, such that the hand rail part is rotated toward the inner space of the lower fixing part.

10. The crane according to claim 1, wherein the transverse current collecting bracket comprises: a guide bracket which is bent in the form of a ‘ [symbol] ’ shape, of which upper end portion is connected to the hoist, and which guides the external power supply to be connected to the hoist; a fastening piece which is fixed to the upper end portion of the guide bracket and is connected to the hoist; and a plurality of fastening bolts fastened to the fastening piece and the hoist,
wherein just one fastening bolt which is the rotation center of the guide bracket and the fastening piece keeps a temporarily assembled state and the remaining fastening bolts are separated, such that the guide bracket and the fastening piece are rotated toward the second girder, and
wherein after rotation, the separated fastening bolts are fastened to the fastening piece and the hoist, such that the rotated guide bracket and the rotated fastening piece are fixed to the hoist.

11. The crane according to claim 3, further comprising:
power lines respectively mounted at the first girder, the second girder and the third girder to supply electric power to driving sources mounted on the unit girders;
cable connectors which are connected to the power lines and are mounted at an end portion of the right side of the first girder, at an end portion of the left side of the second girder and at both end portions of the third girder; and
cable connectors corresponding when the first flange of the first girder and the second flange of the second girder are connected to the third flanges of the third girder.

12. The crane according to claim 1, wherein the hoist clamp comprises:
an operation lever of which one end is rotatably connected to the hoist;
a central shaft connected to the operation lever and the hoist and being a rotation center of the operation lever; and
a detachable link of which one end is connected to the operation lever through a hinge shaft of which the other end is detachably mounted to the support jaw of the girder.

13. The crane according to claim 1, wherein the carrying and packing part comprises:
a pipe of which both ends are fixed to the circumference of the through hole of the girder a packing rod which is inserted into the pipe and of which both end portions are drawn out of the through hole of the girder a base part for supporting the girder a support plate connected to the upper face of the base part in such a manner that the girder is seated on the support plate; a support legs joined below the base part and supported on the floor; a detachable lever rotatably mounted on the base part; and a detachable link of which lower portion is hinge-coupled to the detachable lever and of which upper end portion is detachably mounted at both end portions of the packing rod.
